(19) United States
(12) Patent Application Publication
(10) Pub. No.: US 2007/0226422 A1
(43) Pub. Date: Sep. 27, 2007

(54) MULTI-MASTER SYSTEM AND DATA TRANSFER SYSTEM

(75) Inventors: Yoshiteru MINO, Osaka (JP); Keizo SUMIDA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/681,982

(22) Filed: Mar. 5, 2007

(30) Foreign Application Priority Data
Mar. 8, 2006 (JP) 2006-062490

(51) Int. Cl. G06F 12/00

(52) U.S. Cl. 711/137; 711/147

(57) ABSTRACT

A multi-master system 101 includes: a memory controller 4 that executes access requests for accessing a memory 5 issued from masters 1 through 3; a master 1 that issues a write request for writing the data into a shared area to the memory controller 4; a prefetch control unit 9 that confirms that the data has been written into the shared area, and prefetches the data from the shared area; and a master 2 that is notified by said prefetch unit that the data has been prefetched and that reads the prefetched data.

### BACKGROUND OF THE INVENTION

(1) Field of the Invention

The present invention relates to a multi-master system in which plural masters exchange data via a shared area provided on a memory and, in particular, to a technique for improving system performance in data exchange.

(2) Description of the Related Art

Conventionally, in a multi-master system, in order that data processing should be performed by plural masters in a shared manner, a shared area that can be accessed in common from the masters is pre-set on a memory. Then, one master writes processed data into the shared area, and another master reads the data from the shared area, so that the following data processing is performed. The data exchanged between the masters via the shared area is referred to as shared data in some cases.

An example of data processing is an onscreen display (OSD). As a part of processing in an OSD, one master performs processing for generating a menu screen, and outputs the bit map data of the menu screen to the shared area, and lets the other master be informed. The other master generates text information to be displayed on the menu screen, and performs processing of combining the font data specified by the text information with the bit map data read from the shared area.

FIG. 1 is a schematic configuration diagram showing an example of a conventional multi-master system. A schematic configuration and the operation of the multi-master system are described below with reference to FIG. 1.

A multi-master system 100 shown in this example includes plural masters 1, 2 and 3, a memory controller 4, a memory 5, a cache memory 6, a cache IF 7, a buffer memory 8, and a buffer control unit 10. The memory controller 4 has write buffers (WBs) 11 to 13 for the respective masters.

Memory accesses from the plural masters 1 through 3 are performed via the memory controller 4. After arbitrating plural data transfer requests from the masters 1 through 3, the memory controller 4 accesses the memory 5 in accordance with the data transfer requests selected in an order according to the arbitration result.

At that time, the memory controller 4 performs quick response control in which a transfer completion is notified to the master at the time that the write data from each master is held into the corresponding WB 11 to 13. This quick response control is performed in order to reduce the latency of write accesses from the masters 1 through 3 to the memory controller 4. Then, after holding the write data into the WB 12, when an access request from another master is present, the memory controller 4 performs arbitration successively and executes the access to the memory 5.

Further, in some cases, since a shared area is assigned in an uncacheable memory space, speed improvement in the read access of the shared area cannot be achieved by using a cache memory. In a technique which can be conventionally employed in these cases, the unit amount of data transfer between the memory controller and the memory is increased, in order that a large amount of data should be read from the memory and held into a buffer memory so as to facilitate successive reads within the buffer memory. As a result, a read from the buffer memory can be performed without accessing the memory.

In a technique disclosed as a conventional art of data transfer control from a memory to a buffer memory, when a read from a particular address (the start address or the end address of each data block of 16 bytes) in a buffer memory is detected, a buffer control unit nullifies the buffer memory and updates the data in an area including the particular address, from the memory to the buffer memory (see Japanese Laid-Open Patent Publication No. H6-243037 (page 6 and FIG. 1)).

FIG. 2 is a timing chart of general processing in which plural masters in a multi-master system exchange data via a shared area on a memory, in the case where a master 1 writes data into the shared area and a master 2 reads the data. Major execution cycles of this processing are described below with reference to FIG. 2.

Here, the shared area is defined from address 0 to address 100, a write access to memory address 100 is denoted as a write 100, and read accesses to memory addresses 0 through 3 are collectively denoted as a read 0-3. Further, accesses to the outside of the shared area, for example, to addresses 200 through 299, are assumed to be accesses from masters other than the masters 1 and 2 (such as the master 3).

The master 1 has completed from a write 0 to a write 99 by a cycle T1.

In the cycle T1, the master 1 starts a write 100 into the memory controller 4.

In a cycle T2, after holding the data of the write 100, the WB 11 of the memory controller 4 outputs a write reception response to the master 1.

In a cycle T3, the master 1 starts for the memory controller 4 a read from the same address as the write access, that is, a dummy read 100. This dummy read is performed in order to confirm that the write data held in the WB 11 under quick response control has been written also into the memory 5. After the processing of a read 200 from another master and the write 100 from the master 1, the memory controller 4 processes the read 100.

In a cycle T10, the memory controller 4 completes the read 100 into the memory 5.

In a cycle T11, the master 1 completes the dummy read 100. As a result, the master 1 confirms that the shared data has been written into the memory 5.

In a cycle T12, the master 1 notifies the master 2 of a completion of write.

In a cycle T13, when receiving the write completion notification, the master 2 starts an access to the shared area. First, a read 0 is started for the buffer control unit 10. The buffer control unit 10 converts the read 0 into a collective read 0 to 3 together with the other addresses depending on the unit amount of data transfer of the bus. The memory controller 4 starts the read 0 to 3.

In cycles T17 through T20, the memory controller 4 completes the read 0-3.

In a cycle T18, the buffer control unit 10 completes the read 0.

In a cycle T19, the master 2 completes the read 0.

In a cycle T20, the master 2 starts the read 1. The data of the read 0-3 has been transferred into the buffer memory 8. Thus, the reads 1, 2 and 3 from the master 2 are completed respectively in 2 clock cycles.

As described above, data exchange of addresses 0-3 from the master 1 to the master 2 is completed by a cycle T25. In a cycle T26 and the subsequent cycles, the master 2 performs internal processing, and reads data after address 4.

Nevertheless, the conventional multi-master system has the following problems that degrade the processing performance of respective masters at the time of exchanging data via the shared area on the memory.

A first problem is that the master that writes the shared data needs to perform a dummy read.

As described above, this dummy read is necessary in order to confirm that the write data held in the write buffer under quick response control has been reliably written also into the memory before a read by another master. Thus, additional workload of issuing a dummy read is placed on the master that writes the shared data. In particular, in the case where a large number of cycles are necessary in the dummy read of the shared data mainly because the memory requires a large number of latency cycles, the processing performed by the master could be interrupted owing to a wait for the dummy read completion.

A second problem is that the waiting time necessary for a read of the shared data is not optimized.

After starting a read of the shared data, the master that reads the shared data is forced to wait until the memory controller reads the shared data from the memory. Similarly to the above-mentioned time necessary for the dummy read, this waiting time also increases as the number of the cycles necessary for a read of the shared data increases. Thus, the processing performed by the master could be interrupted owing to the wait for the read completion.

### SUMMARY OF THE INVENTION

The present invention has been devised in view of such a situation. An object of the present invention is to provide: a multi-master system in which processing performance of the system at the time when plural masters exchange data via a shared area on a memory is improved; and a data transfer system applied to this multi-master system.

In order to solve the above-mentioned problems, a multi-master system of the present invention includes plural masters which exchange data using a shared area provided on a memory, the system including: a memory controller that executes access requests for accessing the memory issued from the plural masters; a first master that is one of the plural masters and that issues a write request for writing the data into the shared area to the memory controller; a prefetch unit that confirms that the data has been written into the shared area, prefetches the data from the shared area, and notifies one of the other plural masters that the data has been prefetched; and a second master that is another one of the masters and that is operable to read prefetched data when notified that the data has been prefetched by the prefetch unit.

Further, after the write request, the first master may request the memory controller to perform a read of the data from the shared area, and in response to the completion of the read request, it may notify the prefetch unit of a write completion. Subsequently, the prefetch unit may confirm that the data has been written into the shared area, by receiving the write completion notification from the first master.

Further, after issuing the write request, the first master may notify the prefetch unit of a write completion regardless of whether the data has been written into the shared area. Subsequently, when receiving the write completion notification from the first master, the prefetch unit, in place of the first master, may request the memory controller to perform a read of the data from the shared area, and may confirm that the data has been written into the shared area, on the basis of the completion of the read request.

Further, in addition to the implementation as a multi-master system, the present invention may be implemented as a data transfer system applied to the multi-master system.

When the multi-master system according to the present invention is employed, the necessity of a dummy read of write data performed by the master is avoided. Further, the prefetch reduces the read waiting time for the shared data. Thus, the processing performances of the master that writes the shared data and the master that reads the shared data are improved, in comparison with those in the conventional art.

This improvements in the processing performances are particularly remarkable in the case where a memory having high access latency is used, or alternatively in the case where a memory controller arbitrates accesses from other masters in a period between a write and a dummy read of the shared data.

Further Information about Technical Background to this Application

The disclosure of Japanese Patent Application No. 2006-062490 filed on Mar. 8, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a schematic configuration diagram showing an example of a conventional multi-master system;

FIG. 2 is a timing chart showing an example of conventional multi-master processing;

FIG. 3 is a block diagram showing an example of a functional configuration of a multi-master system 101 in a first embodiment;

FIG. 4 is a block diagram showing an example of an internal functional configuration of a prefetch control unit 9;

FIG. 5 is a flow chart showing an example of processing performed by a master 1;

FIG. 6 is a flow chart showing processing performed by a prefetch control unit 9;

FIG. 7 is a flow chart showing an example of processing performed by a master 2;

FIG. 8 is a timing chart showing an example of an overall operation of a multi-master system 101;

FIG. 9 is a block diagram showing an example of a functional configuration of a multi-master system 102 in a second embodiment;

FIG. 10 is a block diagram showing an example of an internal functional configuration of a prefetch control unit 9a;

FIG. 11 is a flow chart showing an example of processing performed by a master 1a;

FIG. 12 is a flow chart showing an example of processing performed by a prefetch control unit 9a;

FIG. 13 is a timing chart showing an example of an overall operation of a multi-master system 102;

FIG. 14 is a block diagram showing an example of an internal functional configuration of a memory controller 4b;

FIG. 15 is a timing chart showing an example of an overall operation of a multi-master system in a modification;

FIG. 16 is a block diagram showing an example of a functional configuration of a multi-master system 103 in a third embodiment; and

FIG. 17 is a block diagram showing an example of an internal functional configuration of a prefetch control unit 9c.

### DESCRIPTION OF THE PREFERRED EMBODIMENT(S)

### First Embodiment

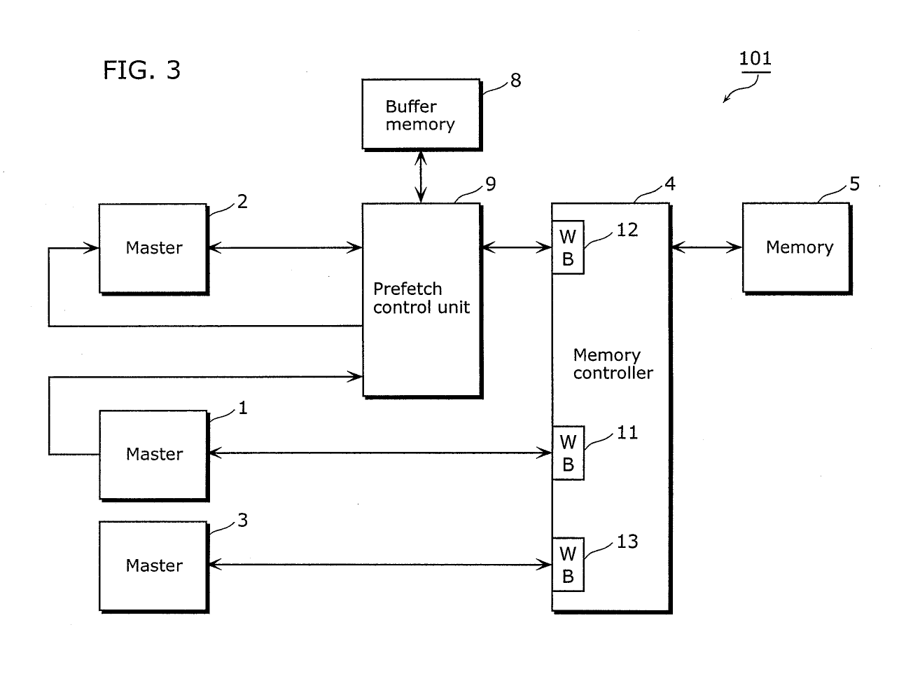

Embodiments of the present invention are described below with reference to FIGS. 3 to 17.

(Overall Configuration)

FIG. 3 is a block diagram showing an example of a functional configuration of a multi-master system 101 in a first embodiment of the present invention. The multi-master system 101 is a system in which shared data written into a memory 5 by a master 1 is prefetched from the memory 5 by a prefetch control unit 9 so as to be referred to by a master 2. The multi-master system 101 includes plural masters 1, 2 and 3, a memory controller 4, a memory 5, a buffer memory 8, and a prefetch control unit 9.

Here, the multi-master system 101 is an example of the multi-master system described in the claims. The prefetch control unit 9 and the buffer memory 8 are an example of the prefetch unit described in the claims. Here, the prefetch control unit 9 and the buffer memory 8 may be implemented in the form of one or more integrated circuit devices separated from the masters 1 through 3. The one or more integrated circuit devices are an example of the data transfer system described in the claims.

The masters 1 and 2 perform data processing in a shared manner while accessing the data in the memory 5 via the memory controller 4. Such processing is referred to as multi-master processing, hereinafter. The masters 1 and 2 perform multi-master processing in such a cooperated manner that shared data written into a shared area of the memory 5 by the master 1 is read by the master 2. In particular, a data access performed by the master 2 is processed via the prefetch control unit 9.

While accessing data in the memory 5 via the memory controller 4, the master 3 performs another data processing independent of the data processing performed by the masters 1 and 2.

The prefetch control unit 9 holds, in the buffer memory 8, data read from the memory 5 by the memory controller 4, and in response to a read request from the master 2, it outputs the data held in the buffer memory 8 to the master 2.

The memory controller 4 arbitrates access requests from the masters 1, 2 and 3, and accesses the memory 5 following one access request according to the result of arbitration.

(Configuration of Prefetch Control Unit 9)

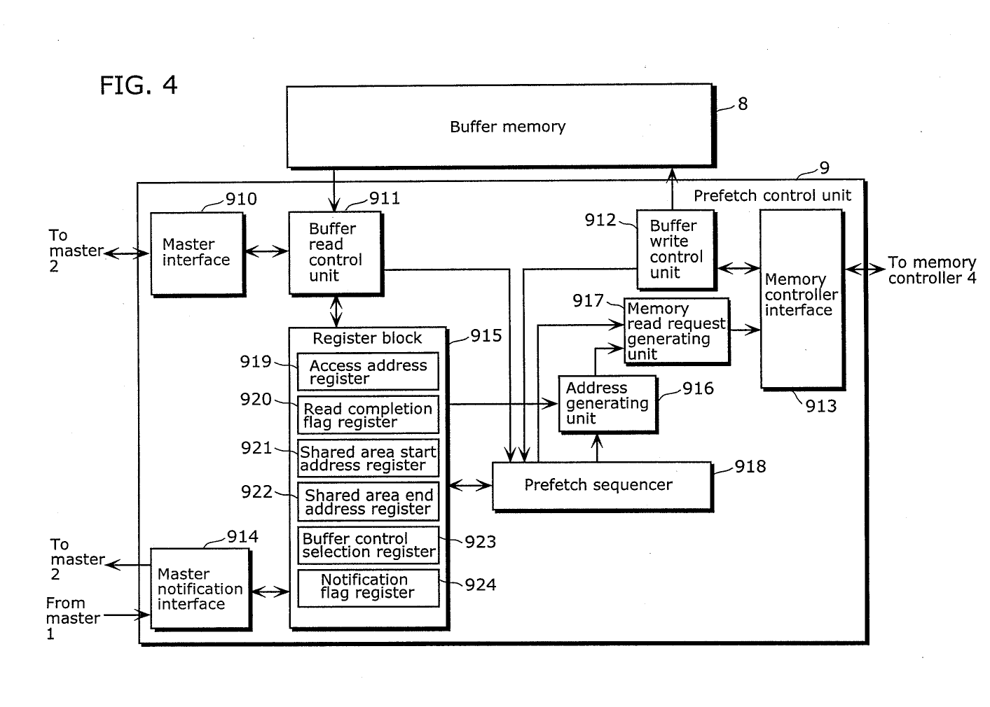

FIG. 4 is a block diagram showing an example of an internal functional configuration of a prefetch control unit 9. The prefetch control unit 9 includes a master interface 910, a buffer read control unit 911, a buffer write control unit 912, a memory controller interface 913, a master notification interface 914, a register block 915, an address generating unit 916, a memory read request generating unit 917, and a prefetch sequencer 918.

In the following description, first, the functions of the respective units are explained in a random order. Next, coordinated operations between these units are explained.

The register block 915 includes an access address register 919, a read completion flag register 920, a shared area start address register 921, a shared area end address register 922, a buffer control selection register 923, and a notification flag register 924.

The access address register 919 holds an address provided from the buffer read control unit 911, and holds a valid bit that indicates whether the address is valid.

The read completion flag register 920 is updated by the buffer read control unit 911, and holds a read completion flag concerning whether the data held in the buffer memory 8 has been read by the master 2.

The shared area start address register 921 and the shared area end address register 922 respectively hold a shared area start address that indicates the starting point of the shared area and a shared area end address that indicates the ending point, which are pre-set before the exchange of data in the shared area.

The buffer control selection register 923 is a register that holds an operation selection flag used for switching data transfer operation to the buffer memory 8. The buffer control selection register 923 is pre-set by the master 2.

The notification flag register 924 is a register that holds a notification flag used for indicating the issuance time of a notification signal to the master 2. The notification flag register 924 is updated by the master notification interface 914 and the prefetch sequencer 918.

The master interface 910 outputs, to the buffer read control unit 911, an access request that contains a read request from the master 2, and outputs, to the master 2, read data outputted from the buffer read control unit 911.

The buffer read control unit 911 compares a read address requested by the master 2 acquired from the master interface 910 with the address held in the access address register 919, and starts up the prefetch sequencer 918 when they do not match each other. When they match each other, the buffer read control unit 911 causes the buffer memory 8 to output data that match the read address to the master interface 910, and in synchronization with the data read-out from the buffer memory 8, records, into the read completion flag register 920, a read completion flag indicating that the data read from the buffer memory 8 has been completed.

Here, when the value of the valid bit of the access address register 919 is set as invalid, the buffer read control unit 911 starts up the prefetch sequencer 918 without comparing the above-mentioned addresses.

The buffer write control unit 912 writes data outputted from the memory controller interface 913 into the buffer memory 8, and notifies the prefetch sequencer 918 of a completion of the write into the buffer memory 8.

The memory controller interface 913 transfers a read access request from the memory read request generating unit 917 to the memory controller 4, and outputs read data returned from the memory controller 4 to the buffer write control unit 912.

When acquiring a write completion notification signal from the master 1, the master notification interface 914 updates, to enable, the notification flag held in the notification flag register 924. Subsequently, the master notification interface 914 detects that the notification flag has been updated from enable to disable, and outputs a read request notice signal to the master 2. The update of the notification flag to disable is performed by the prefetch sequencer 918.

The address generating unit 916 generates an address to be indicated in the read request generated by the memory read request generating unit 917, by using the output of the shared area start address register 921 and the access address register 919.

Under control of the prefetch sequencer 918, the memory read request generating unit 917 generates a read request to the memory controller interface 913.

The prefetch sequencer 918 causes the respective units of the prefetch control unit 9 to operate in cooperation with each other. These coordinated operations are described later in detail.

### Example of Operation

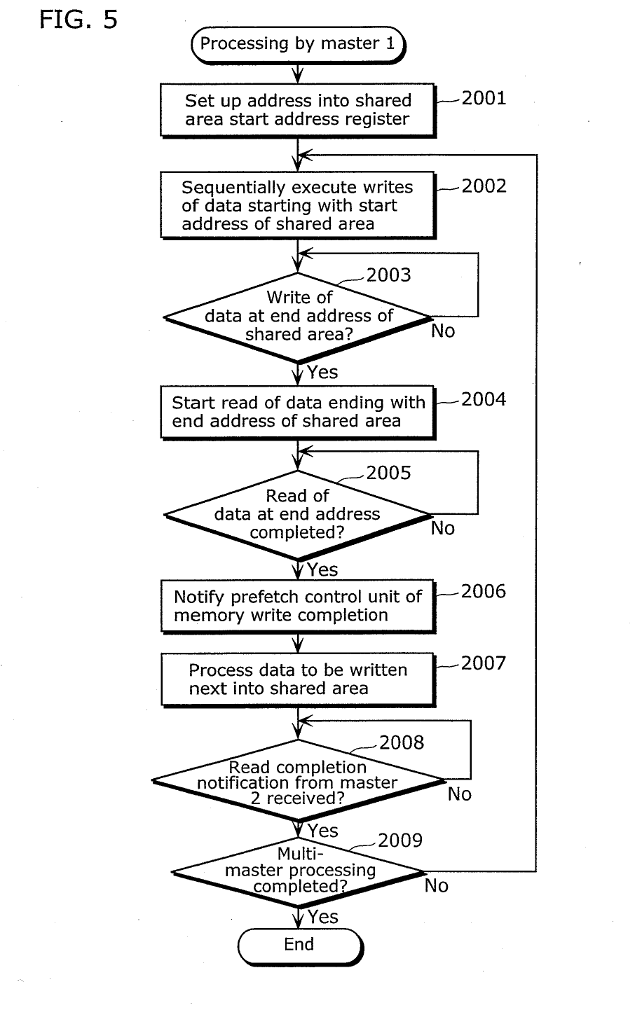

Next, an example of an operation of a main part in the first embodiment of the present invention is described below with reference to FIGS. 5 to 7.

FIG. 5 is a flow chart showing an example of processing performed by the master 1 in the first embodiment of the present invention.

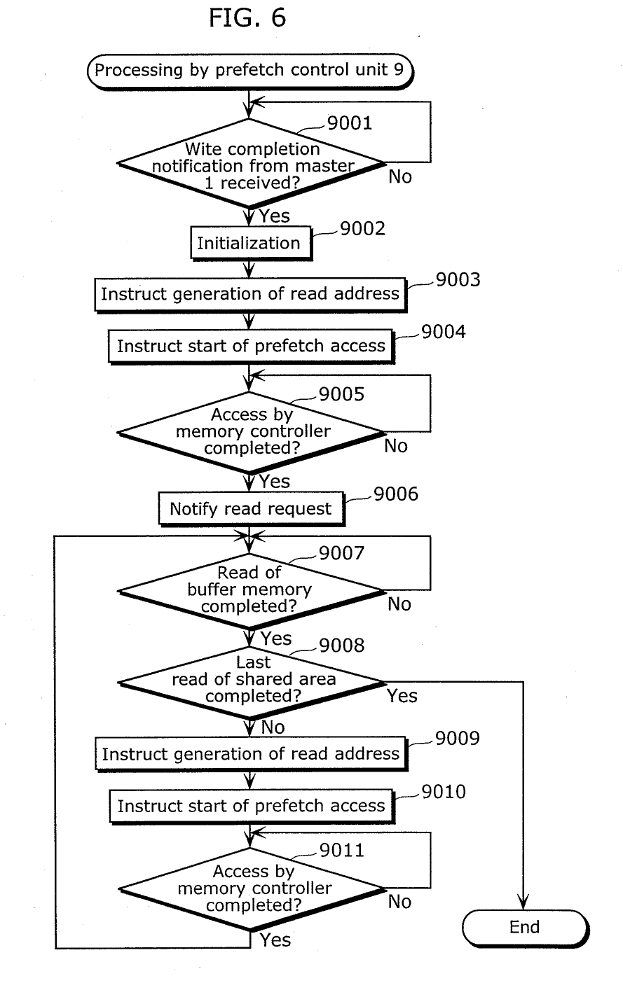

FIG. 6 is a flow chart showing an example of processing performed by the prefetch control unit 9 in the first embodiment of the present invention.

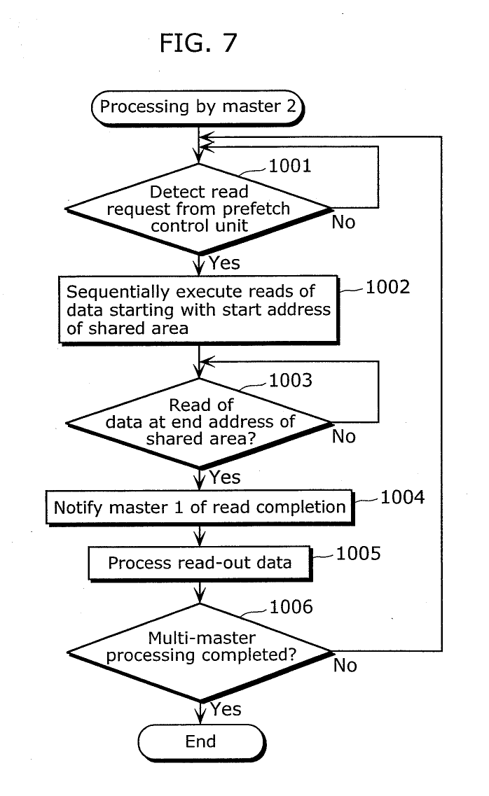

FIG. 7 is a flow chart showing an example of processing performed by the master 2 in the first embodiment of the present invention.

As expected operations, the master 1 and the master 2 are assumed to perform multi-master processing in which data processing is shared by plural masters. In this multi-master processing, the master 1 writes the result of data processing into the shared area pre-set on the memory 5. The master 2 reads the result written by the master 1 from the shared area and performs data processing in the master 2.

(Operation of Master 1)

First, the operation of the master 1 is described below with reference to FIG. 5.

In Step 2001, the master 1 sets up, into the register block 915, information of the shared area defined by the system in the multi-master processing and prefetch control information.

In Step 2002, the master 1 sequentially writes the result of data processing assigned to the master 1 in the multi-master processing, starting with the start address of the shared area.

In Step 2003, the master 1 sequentially writes the data extending to the end address of the shared area.

In Step 2004, the master 1 starts a dummy read from the end address of the shared area.

In Step 2005, the master 1 waits for the completion of the dummy read from the end address of the shared area started in Step 2004. During the cycles of waiting for the completion, the master 1 interrupts the processing.

In Step 2006, the master 1 notifies the prefetch control unit 9 of the completion of write into the shared area.

In Step 2007, the master 1 performs data processing of preparing data to be written next into the shared area.

In Step 2008, the master 1 waits for a notification of completion of read of the shared area from the master 2.

In Step 2009 the master 1 returns to the processing of Step 2002 and repeats the processing of Steps 2002 through 2007 until the multi-master processing is completed.

The reason why the dummy read in Step 2004 is necessary is described below.

The data write processing in Step 2002 is completed when the master 1 issues, to the memory controller 4, a write request for writing the data and then a reception response for the write request is returned from the memory controller 4. The memory controller 4 outputs, to the master 1, a reception response for the write request at the time when the data from the master 1 is held into the write buffer 11. Thus, in the case where the master 1 notifies the master 2 of a read request indicating that the data has been written, in response to the reception response, and then the master 2 requests the memory controller 4 to perform a read of the data, the memory controller 4 may arbitrate the read request of the master 2 and access the memory 5 before the data is actually written into the memory 5.

In this case, a problem arises that the master 2 reads the pre-updated data from the memory 5 before the memory 5 is updated with the data written by the master 1. In order to solve this problem, a dummy read from the address of the write request is performed next to the write of the data to be transferred from the master 1 to the master 2. In general, the memory controller 4 accesses the memory 5 in the order of request for the access requests from the same master. Thus, the completion of the preceding write is ensured at the time that a dummy read has been performed.

(Operation of Prefetch Control Unit 9)

Next, the operation of the prefetch control unit 9 is described with reference to FIG. 6. The operation described here is an example of a coordinated operation controlled by the prefetch sequencer 918.

In Step 9001, the prefetch sequencer 918 waits for a write completion notification from the master 1 into the shared area. The write completion notification from the master 1 is inputted to the master notification interface 914. Then, the master notification interface 914 sets the notification flag held in the notification flag register 924 as enable. When the notification flag is set as enable, the control of the prefetch sequencer 918 goes to Step 9002.

In Step 9002, registers that needs to be initialized in the register block 915 are pre-set. For example, the value of the valid bit of the access address register 919 is set as invalid.

In Step 9003, the prefetch sequencer 918 controls the address generating unit 916 to generate an address to be requested for to the memory controller interface 913 and output the address to the memory read request generating unit 917. In this step, the address generating unit 916 refers to the start address of the shared area from the shared area start address register, and uses it.

In Step 9004, the prefetch sequencer 918 controls the memory read request generating unit 917 to issue a read request to the memory controller interface 913. As a result, the memory controller interface 913 issues a read request for reading prefetching the read data to the memory controller 4. The transfer size in the request may be, for example, the buffer capacity of the buffer memory 8. In general, this capacity is larger than the unit quantity by which the master 2 reads the data.

In Step 9005, the memory controller interface 913 outputs the read data from the memory controller 4 to the buffer write control unit 912. The buffer write control unit 912 writes the read data to the buffer memory 8. The buffer write control unit 912 notifies the prefetch sequencer 918 that the operations for prefetching all the read data have been completed, in synchronization with the operation for writing the lastly read data into the buffer memory 8.

The prefetch sequencer 918 updates the address held in the access address register 919 with the address outputted from the memory read request generating unit 917, and sets the value of the valid bit to valid.

In Step 9006, the prefetch sequencer 918 updates the notification flag held in the notification flag register 924 to disable. The master notification interface 914 detects that the notification flag has been updated from enable to disable, and notifies the master 2 of a read request for reading the shared area.

In Step 9007, control is performed in synchronization with the read operation from the shared area started by the master 2 which has received the notification of the read request for reading the shared area. The data in the shared area is sequentially read starting with the start address of the shared area. The read request from the master 2 is outputted to the buffer read control unit 911 via the master interface 910. The first read request is issued for the data at the start address of the shared area. The data is already held in the buffer memory 8 through the processing of Step 9005. The address held in the access address register 919 indicates the start address of the shared area, while the value of the valid bit is set as valid.

Since the value of the valid bit is set as valid, the buffer read control unit 911 determines that the data for which the master 2 has issued a read request is held in the buffer memory 8. Thus, the buffer read control unit 911 selects the requested data from among the data held in the buffer memory 8, and outputs it to the master 2 via the master interface 910.

When read requests are issued for the subsequent data held in the buffer memory 8, the requested data are sequentially outputted from the buffer memory 8 to the master 2. The data are read sequentially. Then, when it is detected that all the data held in the buffer memory 8 have been read, the prefetch sequencer 918 goes to Step 9008.

In Step 9008, it is detected whether the read request from the master 2 is a read from the end address of the shared area. In the case of a read from the end address, after the completion of the read, the processing performed by the prefetch control unit 9 is terminated. In contrast, in the case of a read from an address in the middle of the shared area, Step 9008 goes to Step 9009 so that the next prefetch operation is performed.

In Step 9009, control similar to that in Step 9003 is performed on the subsequent data. That is, the address generating unit 916 generates, as a new access address, the start address of the area next to the area, in the buffer memory 8, in which data has been held in the preceding process. Here, the start address of the next area can be generated, for example, by adding the size of the data held in the buffer memory 8 to the access address held in the access address register 919.

In Step 9010, the same control as that in Step 9004 is performed.

In Step 9011, the same control as that in Step 9005 is performed. However, after the transfer of the read data from the memory controller 4 to the buffer memory 8, Step 9011 goes to Step 9007.

(Several Detailed Examples of Implementation of Prefetch Control Unit 9)

Next, several detailed examples of implementation of major steps are described below.

In Step 9007, in order to detect that all the data held in the buffer memory 8 have been read, the read completion flag register 920 may, for example, have plural pieces of flag information each indicating whether each of plural parts obtained by dividing the buffer memory 8 has been read by the master 2. In this case, when the entire flag information indicates the completion of the read, that all the data held in the buffer memory 8 have been read can be detected.

Further, when it is known that the data of the buffer memory 8 are read sequentially, it is only necessary to hold flag information indicating whether the data corresponding to the address which is read out last has been read by the master 2. In this case, it is sufficient that a 1-bit read completion flag register corresponding to the end address is installed. This reduces the hardware cost.

Further, in Step 9008, the determination that the read request from the master 2 is a read request to the end address of the shared area may be made on the basis of the complete matching that the buffer read control unit 911 has obtained through comparison between the shared area end address held in the shared area end address register 922 and the address requested for to the buffer read control unit 911 by the master interface 910.

Further, equivalent determination may be made on the basis of whether the access address held in the access address register 919 matches the high order address of the end address of the shared area and whether the read completion flag held in the read completion flag register 920 indicates that all the data held in the buffer memory 8 have been read.

Further, in Steps 9007 through 9011, in order to hide the time for prefetching new data to the buffer memory 8, the buffer memory 8 may be configured with two buffer blocks. In this configuration, the control of the prefetch sequencer 918 is changed so that the buffer read control unit 911 reads a part of the data in the shared area from one buffer block in response to a read request from the master 2, and in parallel that the buffer read control unit 911 prefetches the data of the next part in the shared area to the other buffer block.

This makes it possible to reduce the read latency of the master 2 in comparison with the case where the buffer memory 8 is configured with one buffer block. In contrast, in the case where the buffer memory 8 is configured with one buffer block, the memory controller 4 starts the prefetch of the next data in the shared area after all the data have been read from the buffer block. Thus, the update cycle time of the buffer memory 8 cannot be hidden. Accordingly, it is impossible to avoid the processing performance of the master 2 degrades as the read frequency of the master 2 increases and the number of the cycles between the reads decreases.

Further, as shown in Steps 9001 through 9011, in the duration extending from the time when the write completion notification is received from the master 1 to the time when all the data in the shared area have been read by the master 2, first control for prefetching the new shared data to the buffer memory 8 may be performed at the time when the master 2 has completed the read of the shared data. Further, although not shown in the figure, at the time when an access to data which is not held in the buffer memory 8 is received from the master 2 after all the data in the shared area have been read by the master 2, second control for prefetching the data to the buffer memory 8 may be performed.

For the purpose of this, for example, the prefetch sequencer 918 may switch between the first control and the second control depending on the operation selection flag held in the buffer control selection register 923. Further, the operation selection flag may be set so as to indicate the first control before the master 2 performs the multi-master processing, that is, in the duration extending from the time when the write completion notification is received from the master 1 to the time when all the data in the shared area have been read by the master 2. Furthermore, the operation selection flag may be updated so as to indicate the second control at the time of completion of the multi-master processing, that is, at the time when the master 2 has completed the read of the shared data prefetched to the buffer memory 8.

Here, the first control is suitable in that in the case where the prefetched data is sequentially accessed, the data of the buffer memory 8 is transferred collectively so that the number of accesses from the memory controller 4 to the memory 5 is reduced so as to improve system performance. In contrast, the second control is suitable in that, the amount of data for access to the memory 5 by the memory controller 4 is reduced to the minimum so as to improve system performance in the case where the prefetched data is accessed at random.

It is possible to improve the system performance in accordance with the characteristic of the accesses by using the first control for read accesses to the shared area in multi-master processing in which sequential accesses are dominant and using the second control for read accesses to the outside of the shared area in processing other than multi-master processing in which random accesses are dominant.

Further, the operation selection flag held in the buffer control selection register 923 may be set to be the first control in response to the completion notification of a write into the shared area outputted from the master 1, and may be set to be the second control in response to a read from the end address of the shared area issued from the master 2.

When a hardware logic circuit for performing such setting is provided so as to eliminate the necessity of the register setting processing performed by the software, conventional software for multi-master processing can be used as it is. At the same time, an excellent improvement effect of the system performance is obtained without increasing the multi-master processing cycles due to register setting.

Here, in this embodiment, the case where the master 1 and the master 2 share the data and the prefetch control unit 9 controls the read request to the master 2. However, in the case where data is shared in a system including three or more masters, the function of the master notification interface 914 in the prefetch control unit 9 may be pre-set for all the combinations of the two masters, so that any one of the combinations of the masters may be selected arbitrarily.

(Operation of Master 2)

The operation of the master 2 is described below with reference to FIG. 7.

In Step 1001, when a notification of the read request for reading the shared area is detected from the prefetch control unit 9, Step 1001 goes to Step 1002.

In Step 1002, reads of the data are sequentially performed starting with the start address of the shared area.

Step 1003 goes to Step 1004 when the read of the data at the end address of the shared area has been completed.

In Step 1004, the completion of the read processing for the data in the shared area is notified to the master 1.

In Step 1005, processing of the data read at this process is performed in multi-master processing.

In Step 1006, processing of the data read this time is completed. In the case where the multi-master processing needs be continued, Step 1006 returns to Step 1001 so as to wait for an update of the shared area.

(Operation Timing of Entire System)

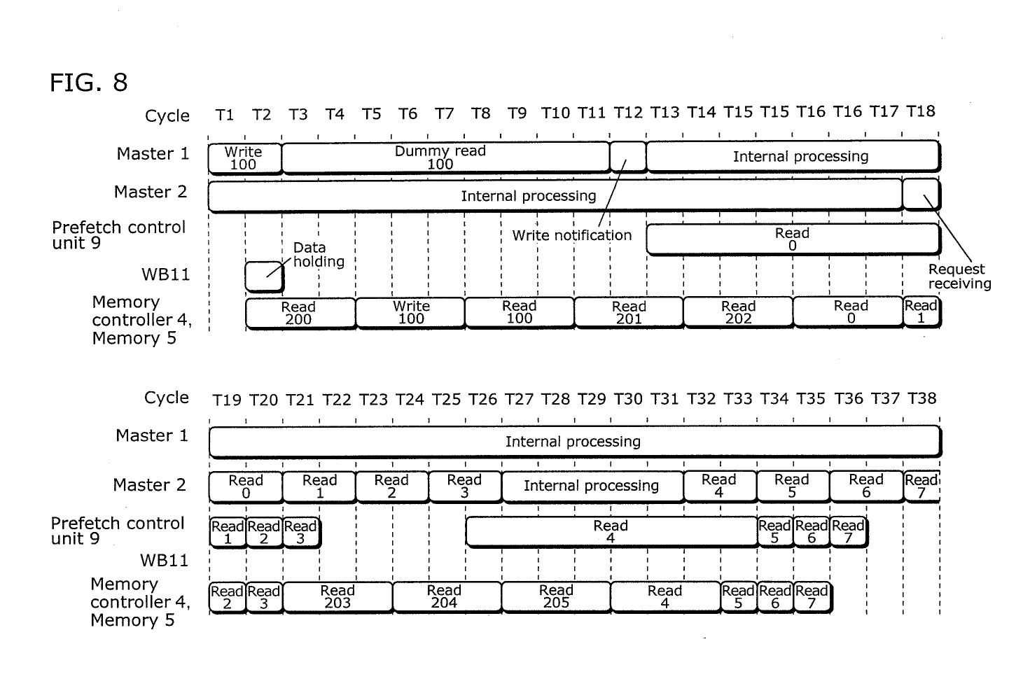

FIG. 8 is a timing chart showing an example of overall operation of a multi-master system 101. Similarly to the description of the conventional art, the shared area is defined from address 0 to address 100, a write access to memory address 100 is denoted as a write 100, and read accesses to memory addresses 0 through 3 are collectively denoted as a read 0-3. Further, accesses to the outside of the shared area, for example, to addresses 200 through 299, are assumed to be accesses from masters (such as the master 3) other than the masters 1 and 2.

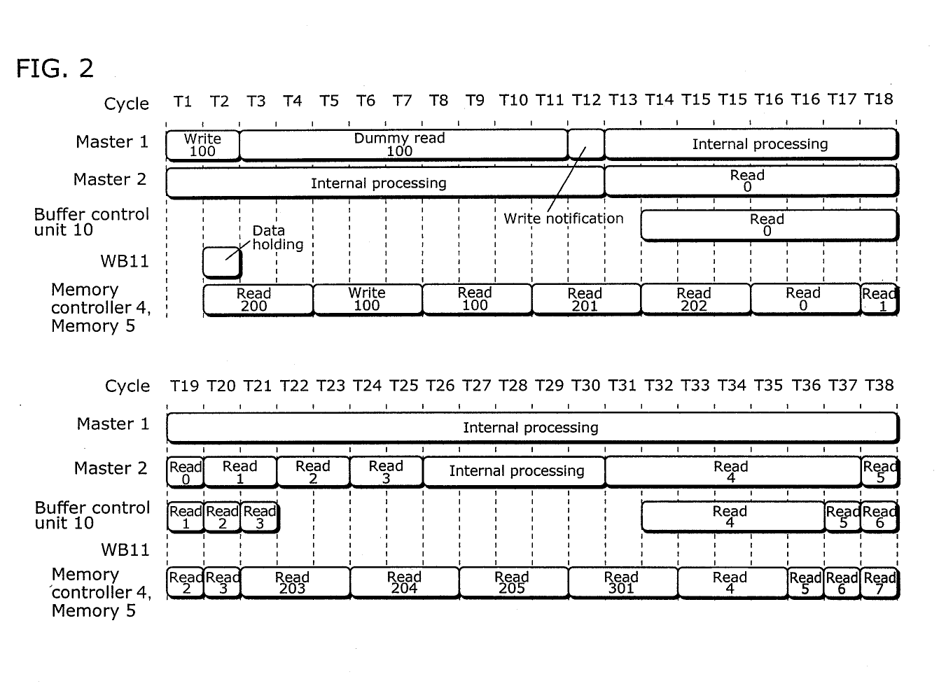

In comparison with the execution cycle (see FIG. 2) in the conventional example, in the execution cycle shown in FIG. 8, the following differences that result in an improvement in the performance of the master 2 are recognized.

First, it is only necessary for the master 2 to start a read from the start address of the shared area after a read request is notified to the master 2. Thus, the start of a read may be performed at a delayed timing in comparison with the conventional art. As a result, the master 2 can execute internal processing in cycles T13 through T17 in which a read has been waited for in the conventional art.

Second, the master 2 can execute the read 4 in the reduced cycles T32 through T33, although it has been executed in cycles T31 through T37 in the conventional art.

Here, the master 2 performs a read from the shared area during multi-master processing. However, the master 2 may perform a read access to the outside of the shared area by processing other than multi-master processing.

When detecting a read access to the outside of the shared area, the buffer read control unit 911 does not need to issue a read request to the buffer memory or a prefetch request to the prefetch sequencer. The buffer read control unit 911 may request directly to the memory controller interface 913 to access the memory controller 4 receive the read data outputted from the memory controller interface 913, and output it to the master 2 via the master interface 910.

### Summary

According to the configuration and processing described above, the data in the shared area is prefetched to the buffer memory 8 by the time that the master 2 starts a read, so that the master 2 can read the prefetched data. Therefore, the latency cycle of a read from the start address of the shared area of the master 2 is reduced by the number of cycles consumed in the case where the processing is performed via the memory controller 4, in comparison with the conventional art.

Further, even in the case where the size of the shared area exceeds the capacity of the buffer memory, it is possible to reduce the latency cycles of a read from the shared area by detecting that all the data prefetched to the buffer memory 8 have been read by the master 2 and adopting a configuration in which the data is prefetched to the buffer memory 8 by the time that the master 2 reads the next data in the shared area.

Here, similarly to the conventional art, the master 1 in the multi-master system of the first embodiment needs to perform a dummy read so as to confirm that the write-requested data has reliably been written in the shared area of the memory 5 from the memory controller 4. In the case where the memory controller 4 processes a dummy access with low priority, processing of accesses from other masters are performed before the dummy access is processed. This increases the cycles from the start to the completion of the dummy access. The master 1 is placed in a state that the processing was stopped, during the time of waiting for the completion of the dummy access. After the completion of the write into the shared area, the master 1 needs to perform multi-master processing successively and perform other processing. Thus, when a dummy access requires a long time, a problem arises that processing performance is degraded in the multi-master processing and other processing. A configuration for resolving this problem is described below in a second embodiment.

### Second Embodiment

A multi-master system in a second embodiment is a multi-master system having a configuration in which the dummy read processing performed by the master 1 in the conventional art and the first embodiment becomes unnecessary.

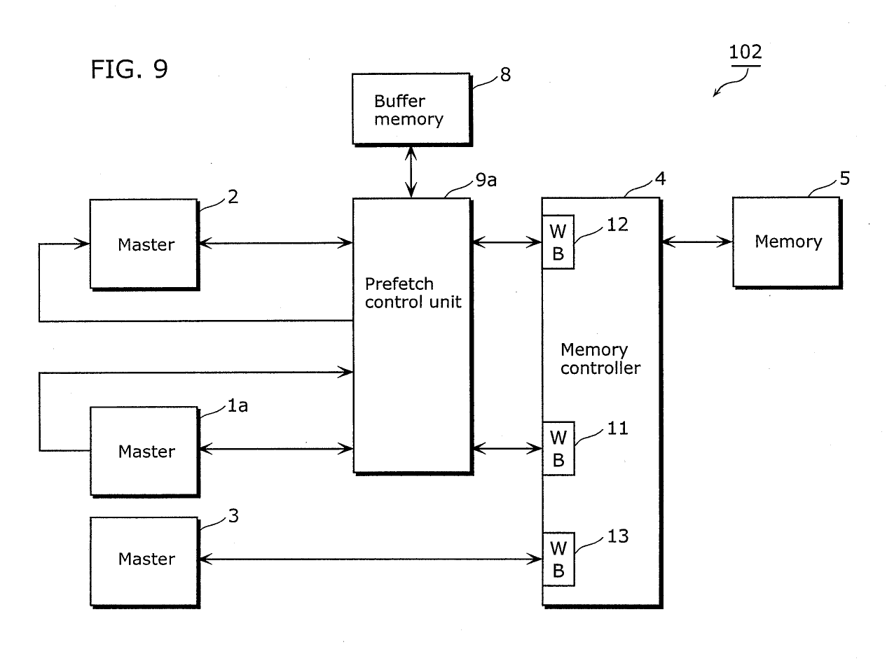

FIG. 9 is a block diagram showing an example of a functional configuration of a multi-master system 102 in a second embodiment of the present invention. The multi-master system 102 has a configuration that the master 1 and the prefetch control unit 9 in the multi-master system 101 (see FIG. 3) of the first embodiment are replaced by a master 1a and a prefetch control unit 9a.

In this configuration, the master 1a does not issue a dummy read, while the prefetch control unit 9a performs the entire processing for the dummy read.

In the following description, the same blocks as those described in the first embodiment are designated by the same numerals, and hence their description is omitted.

In place of directly outputting an access request for accessing the memory 5 to the memory controller 4, the master 1a outputs it to the prefetch control unit 9a.

The master 2 is the same as the master 2 described in the first embodiment.

The prefetch control unit 9a relays an access request acquired from the master 1 to the memory controller 4, and performs processing for a dummy read.

(Configuration of Prefetch Control Unit 9a)

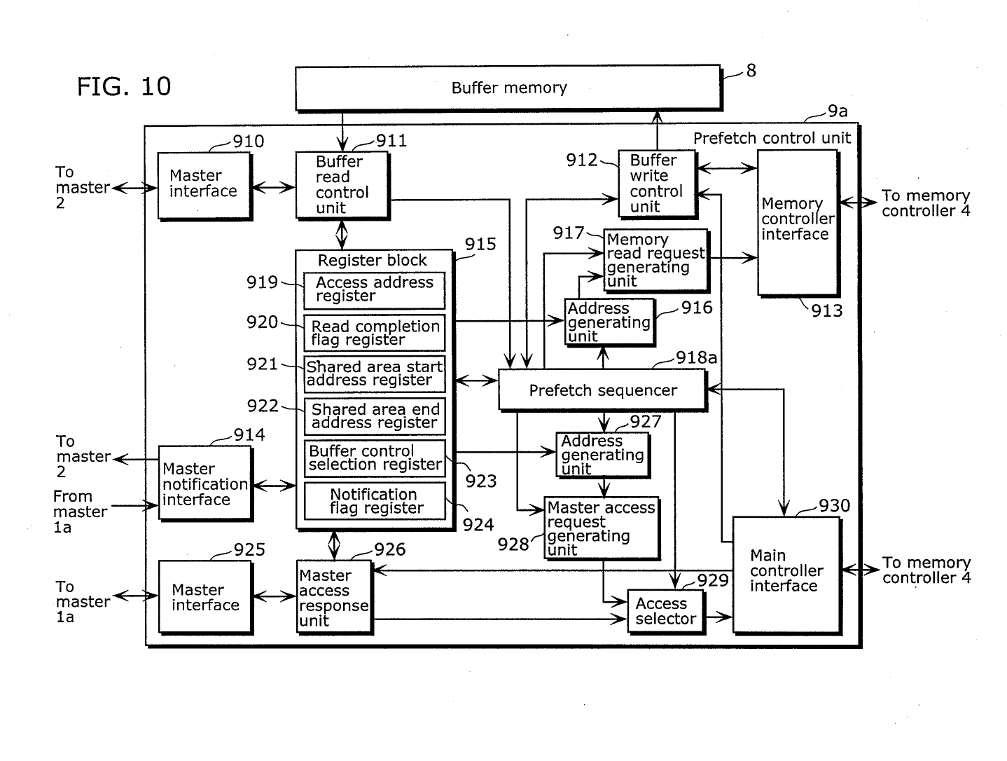

FIG. 10 is a block diagram showing an example of an internal functional configuration of a prefetch control unit 9a. The prefetch control unit 9a is configured to include a prefetch sequencer 918a having a different control sequence which replaces the prefetch sequencer 918 of the prefetch control unit 9 (see FIG. 4) and additionally includes a master interface 925, a master access response unit 926, an address generating unit 927, a master access request generating unit 928, an access selector 929, and a memory controller interface 930.

In the following description, first, the functions of the respective units are explained in a random order. Next, coordinated operation between these units is explained.

The master interface 925 outputs an access request that contains a write request and a read request from the master 1a to the master access response unit 926, and outputs read data to be outputted from the master access response unit 926 to the master 1a.

The master access response unit 926 compares the address of the write request from the master interface 925 with the shared area end address held in the shared area end address register 922, and when they match each other, sets the notification flag held in the notification flag register 924 as enable.

At that time, the master access response unit 926 transfers the write request from the master interface 925 to the memory controller interface 930. The master access response unit 926 may output the dummy response to the master interface 925 before the transfer.

The address generating unit 927 outputs the output of the shared area end address register 922 to the master access request generating unit 928, and generates an address to be indicated in the read request to the memory controller interface 930 generated by the master access request generating unit 928, by using the shared area start address and the access address which are respectively held in the shared area start address register 921 and the access address register 919.

The master access request generating unit 928 generates an access request for accessing the memory controller interface 930.

Under control of the prefetch sequencer 918, the access selector 929 selects one of the access request from the master access response unit 926 and the access request from the master access request generating unit 928, and outputs the selected one to the memory controller interface 930.

In response to a read access request from the access selector 929, the memory controller interface 930 requests an access to the memory controller 4, and outputs read data from the memory controller 4 to the buffer write control unit 912.

Under control of the prefetch sequencer 918, the buffer write control unit 912 selects one of the data outputted from the memory controller interface 913 and the data outputted from the memory controller interface 930, writes the selected one into the buffer memory 8, and notifies the prefetch sequencer 918 of the completion of write into the buffer memory 8.

In response to a read access request from the access selector 929, the memory controller interface 930 requests an access to the memory controller 4, and outputs read data from the memory controller 4 to the buffer write control unit 912.

The prefetch sequencer 918a causes the respective units of the prefetch control unit 9a to operate in cooperation with each other. The coordinated operations are described later in detail.

### Example of Operation

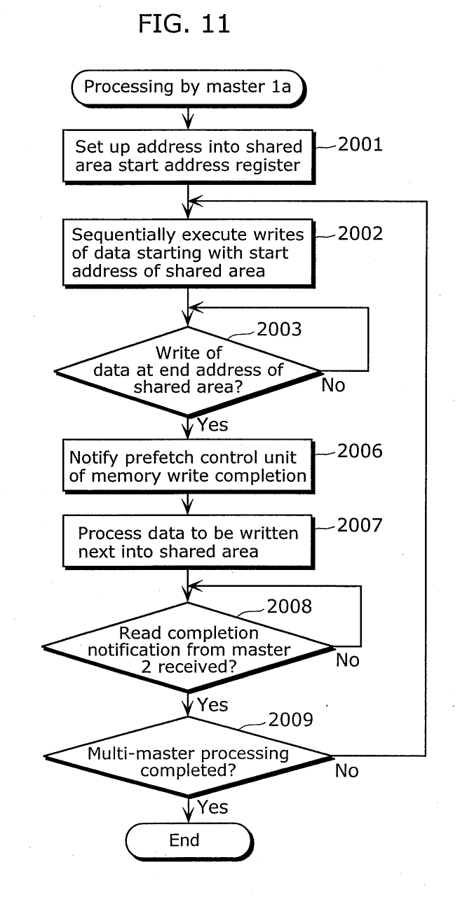

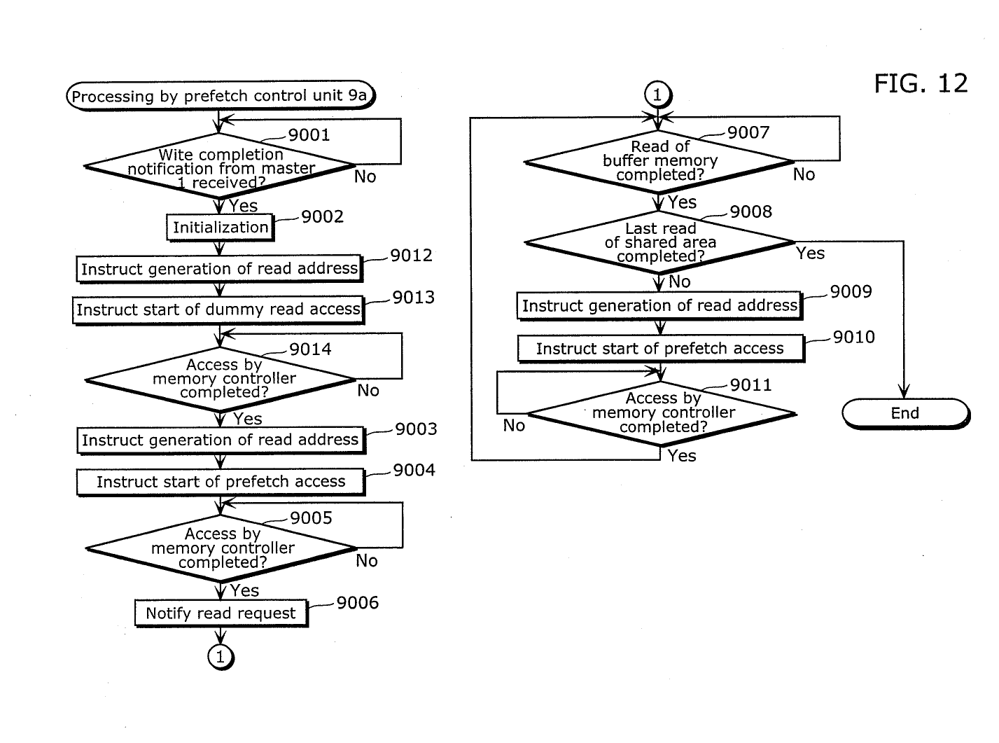

Next, an example of operation of a main part in the second embodiment of the present invention is described below with reference to FIGS. 11 and 12.

FIG. 11 is a flow chart showing an example of processing performed by the master 1a in the second embodiment of the present invention.

FIG. 12 is a flow chart showing an example of processing performed by the prefetch control unit 9a in the second embodiment of the present invention.

(Operation of Master 1a)

First, the operation of the master 1a is described below with reference to FIG. 11. The master 1a performs processing in which Steps 2004 and 2005 are omitted from the processing performed by the master 1 of the first embodiment (see FIG. 5). That is, in the example shown in FIG. 11, the master 1a does not perform a dummy read from the end address of the shared area. Upon requesting a data write into the end address of the shared area in Step 2003, the master 1a notifies the prefetch control unit 9 of the completion of write into the memory in Step 2006. That is, this write completion notification is performed regardless of whether the data has actually been written into the shared area.

(Operation of Prefetch Control Unit 9a)

Next, the operation of the prefetch control unit 9a is described with reference to FIG. 12. In the figure, the same steps as those (see FIG. 6) described in the first embodiment are designated by the same numerals, and hence their description is omitted.

In Step 9001, the prefetch control unit 9a detects the write completion notification from the master 1. The time of this detection is advanced to immediately after the write request to the end address of the shared area made by the master 1a, in comparison with after the dummy read made by the master 1 in the first embodiment.

In Step 9012, under control of the prefetch sequencer 918a, the address generating unit 916 outputs the shared area end address held in the shared area end address register 922 to the master access request generating unit 928.

In Step 9013, under control of the prefetch sequencer 918a, the master access request generating unit 928 generates a dummy read access to the shared area end address in the access selector 929.

In Step 9014, when the dummy read access to the memory controller 4 is completed, the memory controller interface 930 notifies the prefetch sequencer 918a of the completion of the access. Then, the prefetch sequencer 918a transfers the control to Step 9003.

(Operation Timing of Entire System)

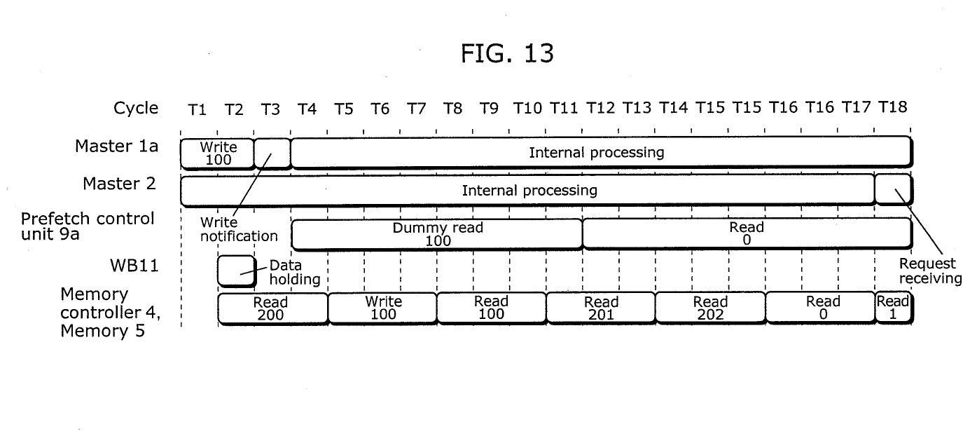

FIG. 13 is a timing chart showing an example of overall operation of a multi-master system 102.

In comparison with the execution cycle (see FIG. 2) in the conventional example, the following differences resulting in an improvement in the performance of the master 1a are recognized in the execution cycle shown in FIG. 13.

That is, the dummy read 100 which have been performed by the master 1 at T3 through T10 in the conventional art is executed instead by the prefetch control unit 9a. Thus, the master 1a does not need to perform the dummy read. Thus, the master 1a can perform a write notification at T3, and internal processing at T4 and subsequent cycles. An example of this internal processing is preparation of data to be transferred to the shared area in the next process in multi-master processing.

### Summary of Second Embodiment

According to the configuration and the processing described above, in place of the master 1a, the prefetch control unit 9a performs a dummy read from the end address of the shared area. Thus, the master 1a can perform internal processing in the time in which a dummy read has been performed by the master 1 in the conventional art. This improves system performance.

### Modification Relevant to Second Embodiment

The above-mentioned description has been given for the case where the prefetch control unit 9a performs a dummy read in place of the master 1a. However, a modification which does not require a dummy read itself is also possible. Such a modification is described below.

A multi-master system in this modification is configured so that the respective memory controller 4 and prefetch control unit 9a perform operations different from those in the multi-master system 102 shown in FIG. 9. The overall configuration of this multi-master system is the same as that of FIG. 9, and hence description is omitted.

In comparison with the memory controller 4, the memory controller 4b is changed so as to newly output an access state signal indicating that the write request to the end address of the shared area issued by the master 1 has been executed to the memory 5.

In comparison with the prefetch control unit 9a, the prefetch control unit 9b is changed such as to detect that a data write requested by the master 1 has been executed to the memory 5, by using the access state signal acquired from the memory controller 4b. For the purpose of this detection, control by the prefetch sequencer 918a in the prefetch control unit 9a shown in FIG. 10 is changed.

In the following description, the prefetch control unit 9a in FIG. 10 is read as a prefetch control unit 9b, and the memory controller 4 is read as a memory controller 4b.

Under control of the modified prefetch sequencer 918a, the prefetch control unit 9b operates as follows.

In response to a write access to the end address of the shared area issued from the master 1, an access request is outputted from the master interface 925 to the master access response unit 926.

The master access response unit 926 notifies the access selector 929 of the access request. After notifying the memory controller interface 930 of the access request, the access selector 929 sets the notification flag held in the notification flag register 924 as enable, and thereby masks the subsequent access requests, from the master interface 925, which do not relate to multi-master processing, so that the access requests are not to be issued to the subsequent stage.

Here, as described above, when acquiring a write completion notification signal from the master 1, the master notification interface 914 may update the notification flag to enable. Even in this case, access requests which do not relate to multi-master processing can be masked.

The memory controller interface 930 notifies the memory controller 4b of the access request. As a result, the write request to the end address of the shared area is notified to the memory controller 4b, so that processing of write into the memory 5 is performed by the memory controller 4b.

When the notification flag is set as enable, the prefetch sequencer 918 waits until the access state signal from the memory controller 4b indicates that the write access from the master 1 has been completed in the memory controller 4b. Subsequently, similarly to the first and the second embodiments, the prefetch sequencer 918 sequentially transfers the data to the buffer memory starting with the start address data of the shared area on the memory, and notifies the master 1 of the completion of the transfer.

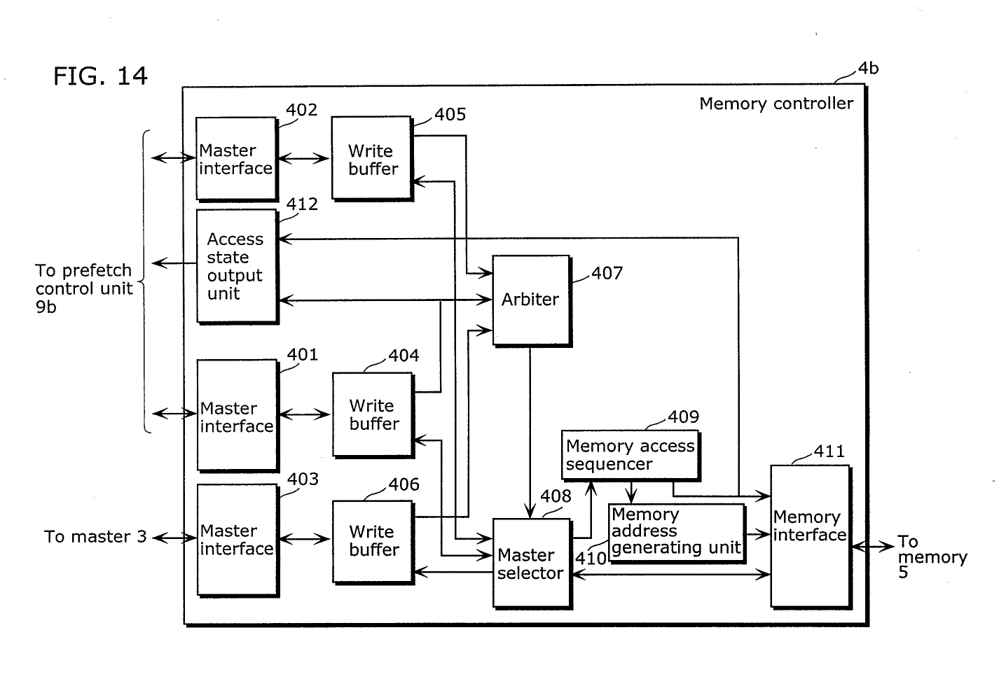

FIG. 14 is a block diagram showing an example of an internal functional configuration of a memory controller 4b.

The master interface 401 controls transfer of a memory access request from the master 1, to and from the prefetch control unit 9b.

The master interface 402 controls transfer of a memory access request from the master 2, to and from the prefetch control unit 9b.

The master interface 403 controls the transfer of a memory access request to and from the master 3.

The write buffer 404 holds write access data from the master interface 401, and at the time of holding it, notifies the master interface 401 of an access completion. Further, when data to be transferred to the memory 5 is present in the write buffer 404, the write buffer 404 notifies the arbiter 407 and the master selector 408 of a transfer request for the data to be transferred.

In relation with the master interface 402, the write buffer 405 has a function corresponding to that of the write buffer 404.

In relation with the master interface 403, the write buffer 406 has a function corresponding to that of the write buffer 404.

Further, the write buffers 404 through 406 have the function of a read buffer that transfers a read request from the corresponding master interface to the arbiter 407 and the master selector 408. In the case where data is present in the write buffers 404 through 406 when a read request is received, the write buffers 404 through 406 output the data to the corresponding master interfaces.

The arbiter 407 arbitrates the access requests from the write buffers 404 through 406, and notifies the master selector 408 of the result of the arbitration.

The master selector 408 has the function of selecting one of the access requests from the write buffers 404 through 406 in accordance with the arbitration result of the arbiter 407 and requesting the memory access sequencer 409 to start a memory access in accordance with the selected access request, and performs data transfer between the memory interface 411 and the write buffers 404 through 406.

The memory access sequencer 409 generates an access sequence defined in advance in accordance with the memory access start request from the master selector 408.

The memory address generating unit 410 generates a memory address under control of the memory access sequencer 409.

The memory interface 411 performs the access control for the data to the memory 5.

The access state output unit 412 monitors an access request of write from the write buffer 404 to the arbiter 407, and outputs a first signal indicating that the request has not been issued to the prefetch control unit 9b. The first signal indicates that write data from the master 1 is not present in the write buffer 404, that is, not suspended. Further, the access state output unit 412 monitors an access request from the memory access sequencer 409 to the memory interface 411, and outputs a second signal indicating that the request has not been issued, that is, the request is not under execution to the prefetch control unit 9b.

A signal obtained as the logical sum of the first and second signals indicates that data to be written from the master 1 to the memory 5 is not present in the memory controller 4b, that is, a write request for writing the data is neither suspended nor under execution. This indicates that the entire write data from the master 1 has been written from the memory controller 4b to the memory 5.

The prefetch control unit 9b can confirm that the data at the end address of the shared area has been written into the memory, on the basis of the signal obtained as the logical sum of the first and second signals acquired from the access state output unit 412.

Here, the access state output unit 412 may output the signal obtained as the logical sum of the first and second signals to the prefetch control unit 9.

(Operation Timing of Entire System)

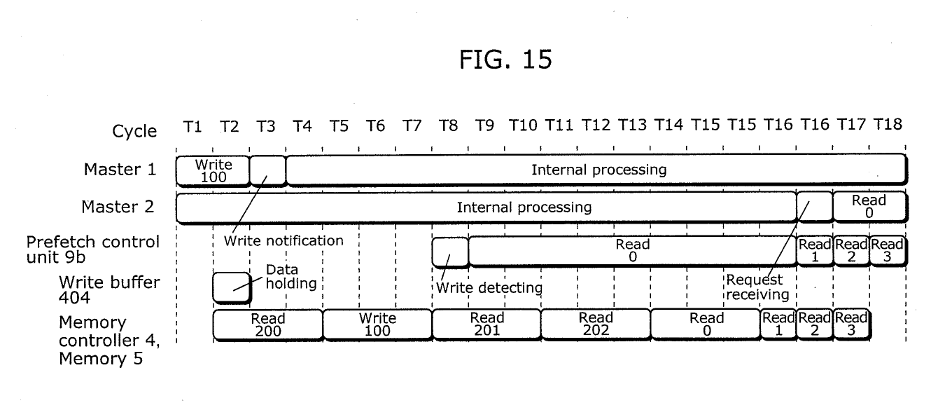

FIG. 15 is a timing chart showing an example of overall operation of a multi-master system in this modification.

In comparison with the execution cycle (see FIG. 13) in the second embodiment, in the execution cycle shown in FIG. 15, the following differences resulting in an improvement in the overall performance of the master 2 and the system are recognized.

First, the dummy read is not performed. Thus, the start time of prefetch of the data in the shared area performed by the prefetch control unit 9b is advanced from T12 to T9. As a result, the turn around time until the master 2 can read the data written by the master 1 is reduced so that the response of the master 2 and the throughput of data transfer are improved.

Second, since the dummy read is not performed, access frequency to the memory controller 4b is reduced, so that system performance is improved.

(Other Modifications)

Here, the prefetch control unit 9a may transfer the prefetch data to the buffer memory 8 by using the data path used for transferring the data relevant to the master 1. In this configuration, under control of the prefetch sequencer 918a, the address generating unit 927, the master access request generating unit 928, and the access selector 929 request a data transfer for prefetch, to the memory controller 4b via the memory controller interface 930. The buffer write control unit 912 writes the prefetch data read from the memory controller 4b in the buffer memory 8.

In this case, Steps 9003 through 9005 and Steps 9009 through 9011 in FIG. 12 are executed by the address generating unit 927 and the master access request generating unit 928.

This configuration is advantageous in the case where the master 1 mainly performs multi-master processing. In this case, the frequency of accesses to the memory 5 in multi-master processing becomes low after the completion of write to the shared area and until completion notification of read from the shared area is issued from the master 2. Thus, when the unused data path of the memory controller 4 for the master 1 is utilized for the prefetch of data to the master 2, system performance is improved.

Further, the second embodiment which has been described relates to a configuration that eliminates the necessity of the dummy read processing performed by the master 1a. However, another modification in which the master 1a requires a dummy read but its waiting time is minimized is also possible.

In this modification, the prefetch control unit 9a immediately returns a response to a dummy read request from the master 1, and thereby minimizes the time that the master 1a waits for a dummy read.

Specifically, the master access response unit 926 compares the shared area end address held in the shared area end address register 922 with the access address indicated in the read request of the master 1a from the master interface 925, and when they match each other, immediately returns a response to the master interface 925. That is, this response is returned to the master 1a as a completion notification of the read request, regardless of whether the read request has actually been executed.

The master access response unit 926 sets the notification flag held in the notification flag register 924 as enable. The prefetch sequencer 918 controls the address generating unit 927, the master access request generating unit 928, the access selector 929, and the memory controller interface 930, and thereby executes a dummy access. The subsequent operation of the prefetch sequencer 918 is the same as that described above. That is, the prefetch sequencer 918 confirms that the data has been written into the shared area, by receiving, from the memory controller 4, an actual completion notification to the dummy access, and performs a prefetch of the data, a notification of the read request to the master 2, and the like (see FIG. 12).

According to this configuration, the time that the master 1a waits for a dummy read is minimized, and therefore it becomes possible to improve system performance.

In the first and second embodiments, since the prefetch control unit 9 performs prefetch control by using the buffer memory 8, there arises a problem that the cost for the hardware of the memory device and the transfer control device increases. A configuration for solving this problem is described below in a third embodiment.

### Third Embodiment

A multi-master system in a third embodiment is configured to realize a function of the buffer memory described above by controlling the cache function in the case where the master 2 has the cache function.

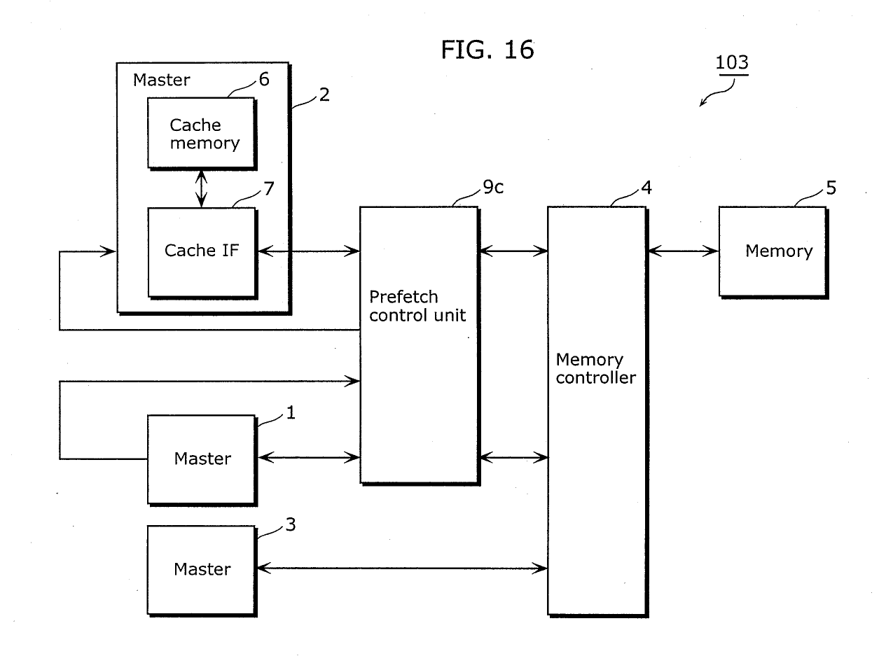

FIG. 16 is a block diagram showing an example of a functional configuration of a multi-master system 103 in a third embodiment of the present invention.

In the following description, the same blocks as those described above are designated by the same numerals, and hence their description is omitted.

The cache system of the master 2 is configured with a cache memory 6 and a cache interface (IF) 7 so that a cache control instruction can be received and executed also from the outside of the master 2. This cache system receives an appropriate cache control instruction from the prefetch control unit, and executes the prefetch of the data in the shared area.

In this embodiment, a precedence fetch instruction and a cache invalidation instruction are used as cache control instructions. The precedence fetch instruction is intended for requesting to transfer, in advance to the cache memory 6, an instruction or data that is to be used in the future, instead of transferring an instruction or data that is to be immediately used in the program under execution by the master 2. When a precedence fetch instruction is provided, the cache IF 7 does not perform anything in the case where an instruction or data at the specified address is already present in the cache memory 6. In the opposite case where an instruction or data is not present in the cache memory 6, the cache IF 7 fetches the data to the line of the cache memory 6 similarly to the case of cache miss in an access from the master 2.

In FIG. 16, the prefetch control unit 9c exchanges data, issues a cache control instruction, and receives a response to and from the cache IF 7.

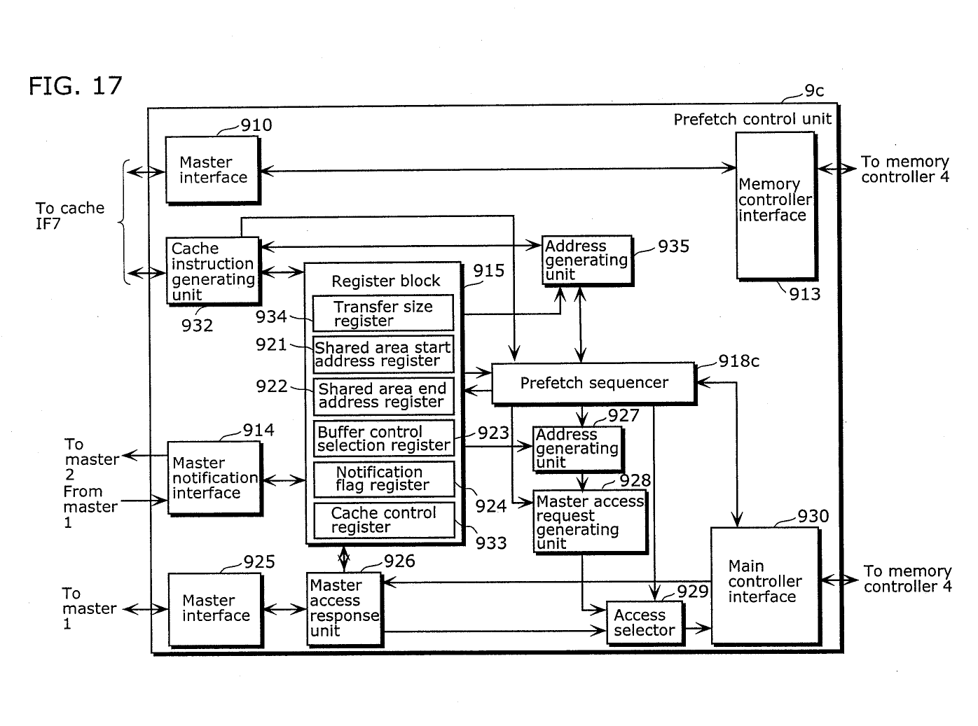

FIG. 17 is a block diagram showing an example of an internal functional configuration of a prefetch control unit 9c.

In accordance with the setting of the cache control register 933, the cache instruction generating unit 932 issues a cache instruction to the cache IF 7. Further, in accordance with a response from the cache IF 7, the cache instruction generating unit 932 notifies the prefetch sequencer 918c of the completion of issuance of a cache instruction.

The cache control register 933 has a field corresponding to the control instruction of the cache IF 7.

When receiving a write completion notification from the master 1, the prefetch sequencer 918c sets up an invalidation instruction in the cache control register 933. When detecting that an invalidation instruction has been set into the cache control register 933, the cache instruction generating unit 932 refers to the shared area start address register 921 and thereby issues an invalidation instruction to the shared area start address to the cache IF 7.

The cache IF 7 invalidates the data of the cache line containing the shared area start address of the cache, and returns a response to the invalidation instruction to the cache instruction generating unit 932. The cache instruction generating unit 932 notifies the prefetch sequencer 918c of the response to the invalidation instruction.

The prefetch sequencer 918c sets up a prefetch instruction in the cache control register 933. When detecting that a prefetch instruction has been set into the cache control register 933, the cache instruction generating unit 932 refers to the shared area start address register 921 and thereby issues a prefetch instruction to the shared area start address to the cache IF 7.

The cache IF 7 searches the cache for the shared area start address data of the cache. Since the data has been invalidated, the cache IF 7 obtains a result that the data does not exist and prefetch the data from the memory 5. After the execution of prefetch, the cache IF 7 returns a response to the cache instruction generating unit 932.

The cache instruction generating unit 932 notifies the response to the prefetch sequencer 918c. The prefetch sequencer 918c sets the notification flag held in the notification flag register 924 as disable.

The master notification interface 914 requests the master 2 to perform a read from the shared area. The master 2 starts a read starting with the start address of the shared area. Since data of the cache line size containing the start address of the shared area is held in the cache memory 6, a read of the data is performed from the cache memory 6.

### Summary of Third Embodiment

According to the configuration described above, a buffer memory for prefetching data in the shared area is realized by using a cache system provided in the master 2. This reduces the hardware cost drastically. Further, it becomes possible to perform a random access to and reuse the data transferred to the cache.

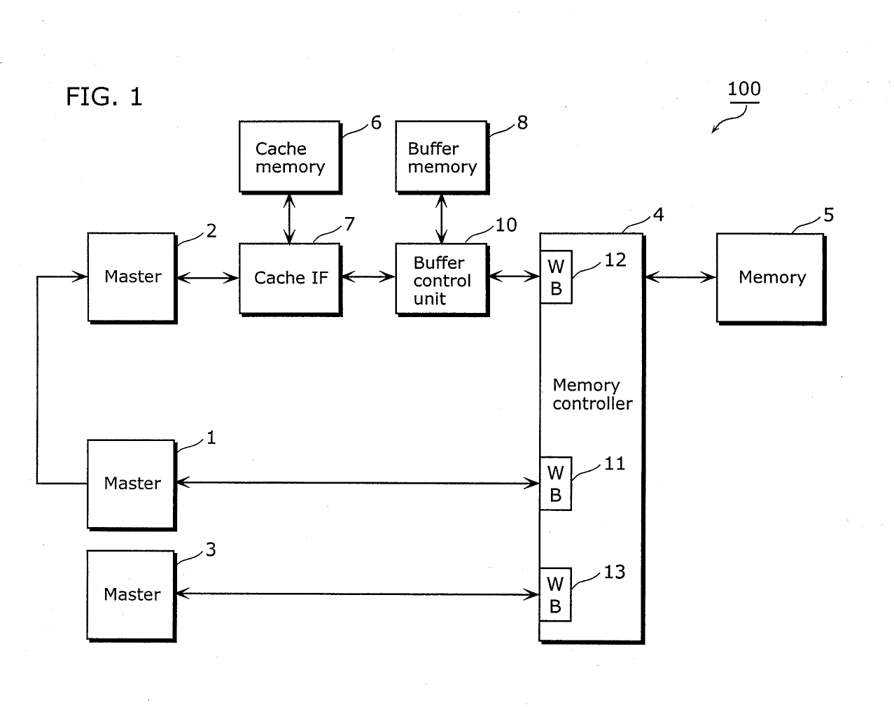

Here, the present embodiment which has been described relates to the case where the master 2 has a cache system. However, the scope of the present invention includes also a case where this cache system is provided in the outside of the master 2 and caches the data accessed by the master 2, for example, as shown in FIG. 1.

### Modifications Relevant to Third Embodiment

Here, a transfer size register 934 may be added to the register block 915, and the size of data transferred to the cache memory 6 by the time of notifying the master 2 of a read request for reading the shared area may be pre-set in the transfer size register 934. The address generating unit 935 generates one or more addresses that are incremented from the start address of the shared area to the data transfer size pre-set in the transfer size register 934 by the prefetch size which is the amount of data prefetched at one time, for the purpose of issuing a prefetch instruction. The prefetch sequencer 918c repeats the setting of a cache control instruction into the cache control register 933 for the purpose of issuing a prefetch instruction to each generated address until it is notified, by the address generating unit 935, that the data transfer size has been filled and thereby there is no need to issue a prefetch instruction.

According to this configuration, in the case where the shared area has a size contained within a part of the cache, the entire shared data is placed in the cache. Thus, memory access is not performed in a read of the shared area in multi-master processing performed by the master 2. Accordingly, read performance degradation caused by an increase in the latency due to the memory controller factor in the arbitration with other masters does not occur, which has occurred in the conventional art. Thus, it is possible to eliminate an influence to multi-master processing and processing of other masters, and therefore system performance is improved.

Further, although not shown in the figure, the access size from the memory controller 4 to the memory 5 may be increased by adding the read buffer (the buffer memory 8 shown in FIG. 3) of the first embodiment and causing the prefetch control unit 9c to request the memory controller 4 to transfer a size obtained by adding the read buffer size and the cache line size. In this case, the prefetch sequencer 918 generates a sequence of making a request to the memory controller 4, once per plural times of prefetch instructions issued to the cache IF 7.

When the transfer size from the memory controller 4 to the memory 5 is increased, in the memory controller 4, the frequency of arbitration can be reduced. This improves system performance and makes it possible to perform prefetch at high speed.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

According to the multi-master system and the data transfer system of the present invention, in a system in which plural masters share an external memory and exchange data between the masters, data consistency is ensured between a data buffer provided in a master interface corresponding to each master and the external memory. Further, the transfer cycle of the shared data can be performed at high speed. Thus, the present invention is useful for the application in a system LSI or the like that adopts a unified memory architecture.

What is claimed is:

1. A multi-master system in which a plurality of masters exchange data using a shared area provided on a memory, comprising:
a memory controller operable to execute access requests for accessing the memory issued from said plurality of masters;
a first master that is one of said plurality of masters and that is operable to issue a write request for writing the data into the shared area to said memory controller;
a prefetch unit operable to confirm that the data has been written into the shared area, prefetch the data from the shared area, and notify another one of said plurality of masters that the data has been prefetched; and
a second master that is the another one of said masters and that is operable to read the prefetched data when notified by said prefetch unit that the data has been prefetched.

2. The multi-master system according to claim 1,
wherein after the write request, said first master is operable to request said memory controller to perform a read of the data from the shared area, and in response to a completion of the read request, to notify said prefetch unit of a write completion, and
said prefetch unit is operable to confirm that the data has been written into the shared area, by receiving the notification of the write completion from said first master.

3. The multi-master system according to claim 2,
wherein said prefetch unit is operable to prefetch the data by a unit larger than a unit read by said second master.

4. The multi-master system according to claim 3,
wherein said prefetch unit is operable to hold plural pieces of flag information each indicating whether each of a plurality of parts obtained by dividing the prefetched data has been read by said second master, and when the held plural pieces of flag information indicate that all the parts have been read by said second master, to prefetch new data from the shared area.

5. The multi-master system according to claim 3,
wherein said second master is operable to read the prefetched data in order of the addresses, and
said prefetch unit is operable to hold flag information indicating whether data at an end address among the prefetched data has been read by said second master, and when the held flag information indicates that the data at the end address has been read by said second master, to prefetch new data from the shared area.

6. The multi-master system according to claim 3,
wherein said prefetch unit
has a buffer memory with a plurality of parts in which prefetched data pieces are respectively held, and
is operable to prefetch new data from the shared area to another part when the data held in one part is read by said second master.

7. The multi-master system according to claim 2,
wherein said prefetch unit
holds flag information that separately indicates: a first duration from a time when the notification of the write completion is received from said first master to a time when all the prefetched data of the shared area are read by said second master; and a second duration other than the first duration,
is operable to prefetch new data from the shared area when all the prefetched data have been read by said second master, in a case where the held flag information indicates the first duration, and
is operable to prefetch new data from the shared area when receiving, from said second master, a read request for reading data stored in an address which is different from an address of the prefetched data, in a case where the held flag information indicates the second duration.

8. The multi-master system according to claim 2,
wherein said prefetch unit
has a shared area end address register that holds an end address of the shared area,
is operable to prefetch new data from the shared area when all the prefetched data have been read by said second master, in a duration from a time when the notification of write completion is received from said first master to a time when processing of the read request to the address held in the shared area end address register issued from said second master is completed, and
is operable to prefetch new data from the shared area when receiving, from said second master, a read request for reading data stored in an address different from an address of the prefetched data, in other durations.

9. The multi-master system according to claim 1,
wherein after issuing the write request, said first master is operable to notify said prefetch unit of a write completion, regardless of whether the data has been written into the shared area, and
when receiving the notification of write completion from said first master, said prefetch unit, in place of said first master, is operable to request said memory controller to perform a read of the data from the shared area, and to confirm that the data has been written into the shared area, on the basis of the completion of the read request.

10. The multi-master system according to claim 1,
wherein after issuing the write request, said first master is operable to notify said prefetch unit of a write completion regardless of whether the data has been written into the shared area,
said memory controller outputs, to said prefetch unit, an access state signal indicating whether the write request is suspended or under execution in said memory controller, and
when receiving the notification of write completion from said first master, said prefetch unit is operable to mask a new access request from said first master so that the access request is not issued to said memory controller, and to subsequently confirm that the data has been written into the shared area, when the access state signal indicates neither that the write request is suspended nor that the write request is under execution.

11. The multi-master system according to claim 1,
wherein said prefetch controlling unit is operable to prefetch the data from the shared area via a data path used in data transfer for said first master.

12. The multi-master system according to claim 1,
wherein after the write request, said first master is operable to request said memory controller via said prefetch unit to perform a read of the data from the shared area, and
said prefetch unit is operable to relay the read request from said first master to said memory controller, to notify said first master of a completion of said read request, regardless of whether said read request has been executed by said memory controller, and to subsequently confirm that the data has been written into the shared area, by receiving an actual completion notification from said memory controller.

13. The multi-master system according to claim 1, further comprising
a cache unit operable to cache the data on the memory for said second master,
wherein said prefetch unit is operable to provide said cache unit with a prefetch instruction so as to cause said cache unit to prefetch the data, and
said second master is operable to read the prefetched data from said cache unit.

14. The multi-master system according to claim 13,
wherein said prefetch unit has a setting of a data transfer size by which data is transferred from the shared area to the cache unit, and is operable to provide said cache unit with prefetch instructions of a number which is in accordance with the pre-set data transfer size, while incrementing a requested address by a prefetch size, and
said cache unit is operable to prefetch the shared data of the data transfer size counted from a start address of the shared area, and to request said second master to perform a read from the shared area starting with the start address.

15. The multi-master system according to claim 13,
wherein said second master is operable to output a data transfer request to said memory controller via the cache and a buffer memory, and
said prefetch controlling unit
is operable to provide said cache control unit with a prefetch instruction indicating a prefetch line size,
to request said memory controller to transfer, from the shared area, the collective data of a size obtained by adding the prefetch line size and the buffer memory size, and
to alternately perform first control of causing said cache unit and the buffer memory to separately hold data of the prefetch line size counted from the start address and the remaining data among the data transferred from the shared area by said memory controller and second control of outputting a prefetch instruction indicating the prefetch line size to said cache unit.

16. A data transfer system for controlling data transfer performed between a plurality of masters by using a shared area provided on a memory, comprising
a prefetch unit operable to confirm that data has been written into the shared area from one of said plurality of masters, prefetch the data from the shared area, and notify another one of said masters that the data has been prefetched.
